(19) United States
(12) Patent Application Publication
(10) Pub. No.: US 2026/0056733 A1
(43) Pub. Date: Feb. 26, 2026

(54) SYSTEM AND METHOD FOR SOURCE CODE AUTO-PROPAGATION AMONGST BRANCHES IN A REPOSITORY

(71) Applicant: Verizon Patent and Licensing Inc., Basking Ridge, NJ (US)

(72) Inventors: Rohit Goyal, Hyderabad (IN); Kamalapriya Panneerselvam, Mayiladuthurai District (IN)

(21) Appl. No.: 18/814,673

(22) Filed: Aug. 26, 2024

(51) Int. Cl. G06F 8/71

(52) U.S. Cl. CPC G06F 8/71

(57) ABSTRACT

One or more computing devices, systems, and/or methods for code auto-propagation amongst branches of a software development project are provided. A source branch, of the software development project, is identified for which auto-propagation is enabled for code modifications to the source branch. The software development project is evaluated to identify a destination branch to which the code modifications are to be propagated. In response to identifying a trigger associated with the auto-propagation for the source branch, a code modification made to the source branch is identified. A merge request is automatically generated to merge the code modification from the source branch to the destination branch. The merge request is executed to merge the code modification from the source branch to the destination branch.

### BACKGROUND

Many different developers may work on a software development project. For example, a first development team may work on a first feature (e.g., an online shopping experience feature), a second development team may work on a second feature (e.g., a customer support feature), etc. The different features may be included as part of various releases of a production version of the software development project such as a shopping website or app that is accessible to users. In this way, the software development project provides multiple developers with the ability to work on different features that can be included in different releases of the production version of the website or app.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for performing auto-propagation of code modifications amongst branches of a software development project, in accordance with an embodiment of the present technology;

FIG. 2 is a flow chart illustrating an example method for performing auto-propagation of code modifications amongst branches of a software development project, in accordance with an embodiment of the present technology;

FIG. 3 illustrates an example of a system for performing auto-propagation of code modifications amongst branches of a software development project, in accordance with an embodiment of the present technology;

FIG. 4A is a flow chart illustrating an example method for performing auto-propagation of code modifications amongst branches of a software development project, where code modifications are auto-propagated from release version branches to a master branch, in accordance with an embodiment of the present technology;

FIG. 4B is a flow chart illustrating an example method for performing auto-propagation of code modifications amongst branches of a software development project, where code modifications are auto-propagated from feature branches to release version branches, in accordance with an embodiment of the present technology;

FIG. 5 illustrates an example of a system for providing a notification regarding the auto-propagation of code modifications amongst branches of a software development project, in accordance with an embodiment of the present technology;

FIG. 6 is an illustration of example networks that may utilize and/or implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

Systems and methods are provided for source code auto-propagation amongst branches of a software development project stored in a versioning repository (e.g., GITHUB or the like). With software development, efficiency, standardized workflows, and automated processes enable faster software development, delivery, and updates. Certain aspects of software development are very time consuming however, involving a significant amount of manual effort, and are prone to user errors. Merging code modifications made in one branch with another branch of the software project is a manual process that is time consuming and can result in errors. In particular, the software development project may include various branches such as a master branch corresponding to a production version of a code base (e.g., a version of an application currently deployed for users), release version branches corresponding to different release versions of the code base, feature branches corresponding to different features that may be implemented by different developers, and/or other types of branches. A developer may perform code modifications to a feature branch (e.g., create a new feature for the application), which can be manually merged into a release version branch. Code modifications to a release version branch may be manually merged into the master branch. Manual code merging is time consuming and becomes complex as there are can be multiple developers working on different features and releases represented by hundreds of branches. Because the code merging is manually performed, there is a risk of human error and can result in a lack of consistent code propagation.

The disclosed techniques overcome these technical challenges by automatically merging code modifications amongst branches based upon various triggers and rules. A user can specify a trigger (rule) for a branch such that when conditions of the trigger are met, corresponding code modifications to that branch are automatically propagated to one or more target branches. In some embodiments, the disclosed auto-propagation of code modifications may be implemented as an add-on feature for a software versioning repository (e.g., GITHUB, or other software version control tool) in order to provide auto-propagation functionality not natively supported by existing repositories and the software used to access them. The auto-propagation functionality may be selectively enabled or disabled for certain branches of the software development project, and may be customized to provide notifications of when code modifications are automatically merged (e.g., when a merge request is created and/or executed) and/or when a code issue is identified. In this way, the auto-propagation functionality provides automated functionality not natively supported by the software development platform so that code modifications can be automatically merged.

The merging of code modifications is automated and triggered based upon conditional criteria without manual intervention, which drastically reduces the amount of manual effort, time, and potential errors from manually merging code, thus improving the efficiency of code development. The auto-propagation functionality is an automated process that minimizes the chances of introducing errors that could otherwise result from manual code merges. The auto-propagation functionality ensures that code is consistently propagated across selected branches for which auto-propagation is selectively enabled. The auto-propagation functionality creates and executes merge requests to merge code modifications, and the merge requests are associated with relevant triggers (rules or conditions). The generation and execution of merge requests and/or encountered errors are described to users through notifications so that the users have visibility into how code modifications are being auto-propagated and can easily identify and resolve errors and issues.

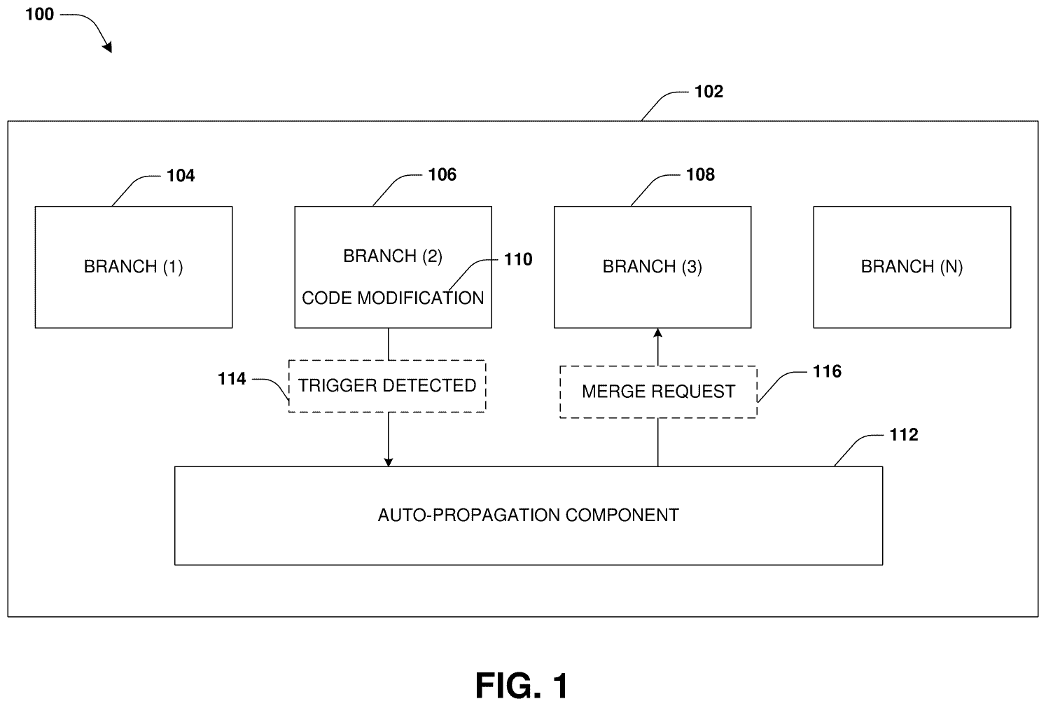

FIG. 1 illustrates an example of a system 100 for performing auto-propagation of code modifications amongst branches of a software development project 102. The source code for the software development project 102 may be stored in a versioning repository (e.g., Gitlab). The software development project 102 may include various branches such as a first branch 104, a second branch 106, a third branch 108, and/or other branches. The branches may include feature branches (e.g., a security feature of an application, a messaging feature of the application, etc.), release version branches (e.g., a particular release version of the application), a master branch (e.g., a production version of the application deployed on client devices), developer branches, staging branches, etc.

An auto-propagation component 112 may be configured to perform auto-propagation of code modifications amongst branches of the software development project 102. In some embodiments, the auto-propagation component 112 may be implemented as an auto-propagation add-on (e.g., a plugin) into a software development platform hosting the software development project 102. The auto-propagation component 112 may provide users with the ability to define triggers for branches. A trigger may specify that when a certain condition occurs, then auto-propagation of code modifications is to be automatically performed. The trigger may specify a source branch and one or more destination branches such that code modifications to the source branch are automatically propagated to (merged into) the one or more destination branches upon occurrence of the trigger. Auto-propagation of code modifications may be selectively enabled or disabled for certain branches, and notifications may be generated for when a merge request is created and executed for auto-propagation code modifications. In some embodiments, a trigger may relate to a code modification or a dependency change. In some embodiments, a trigger may have one or more conditions. For example, a condition may be satisfied when a code commit condition occurs, which may relate to a certain file type (e.g., a code commit for all .yaml files). A condition may be satisfied when code changes are performed on a specific file (e.g., index. html). A condition may be satisfied when there is an application configuration change. A condition may be satisfied when business logic changes. A condition may be satisfied when there is a commit on a branch. A condition may be satisfied when an internal dependency is modified (e.g., Maven or Gradle such pom.xml). A trigger may be scheduled to run at the end of an Agile Sprint or after a demo, or on a particular day. A condition may be satisfied when code is released to a production version. A condition may be satisfied when changes are merged to a main or protected branch.

In some embodiments, a trigger (rule) may be defined for the second branch 106 as a source branch and the third branch 108 as a destination branch. The auto-propagation component 112 may monitor the software development project 102 and/or the software development platform to determine whether conditions of the trigger are satisfied. In response to detecting 114 that the conditions of the trigger are satisfied, the auto-propagation component 112 identifies code modifications 110 that were made to the second branch 106 (e.g., modifications to an inventory lookup API to additional search to date). The auto-propagation component 112 generates and executes a merge request 116 to merge the code modifications 110 of the second branch 106 to the third branch 108. In this way, the code modifications 110 are automatically propagated without manual intervention.

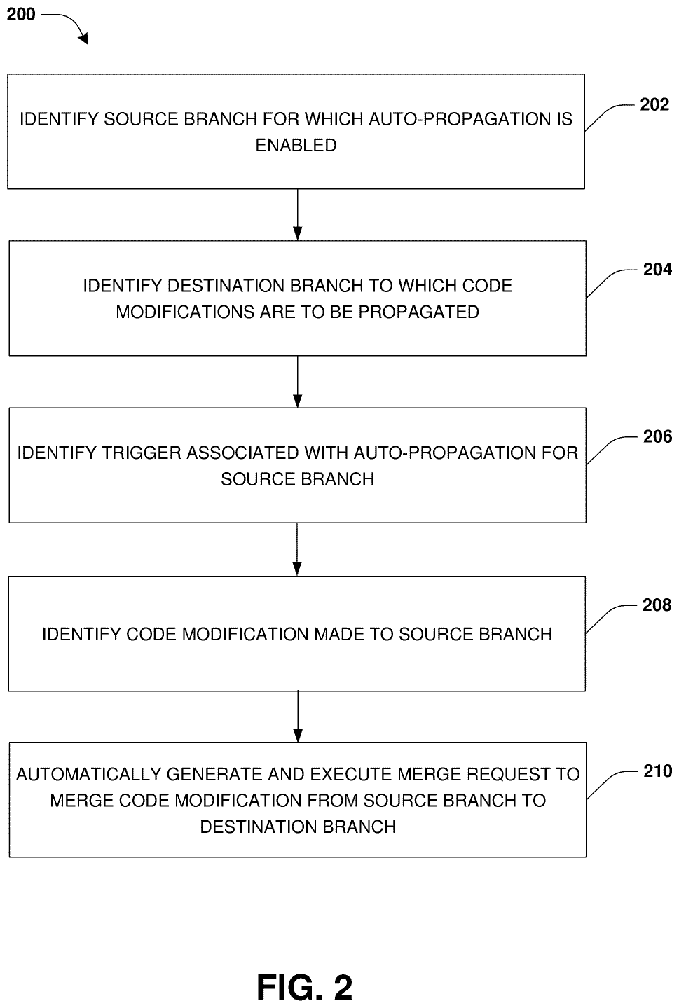

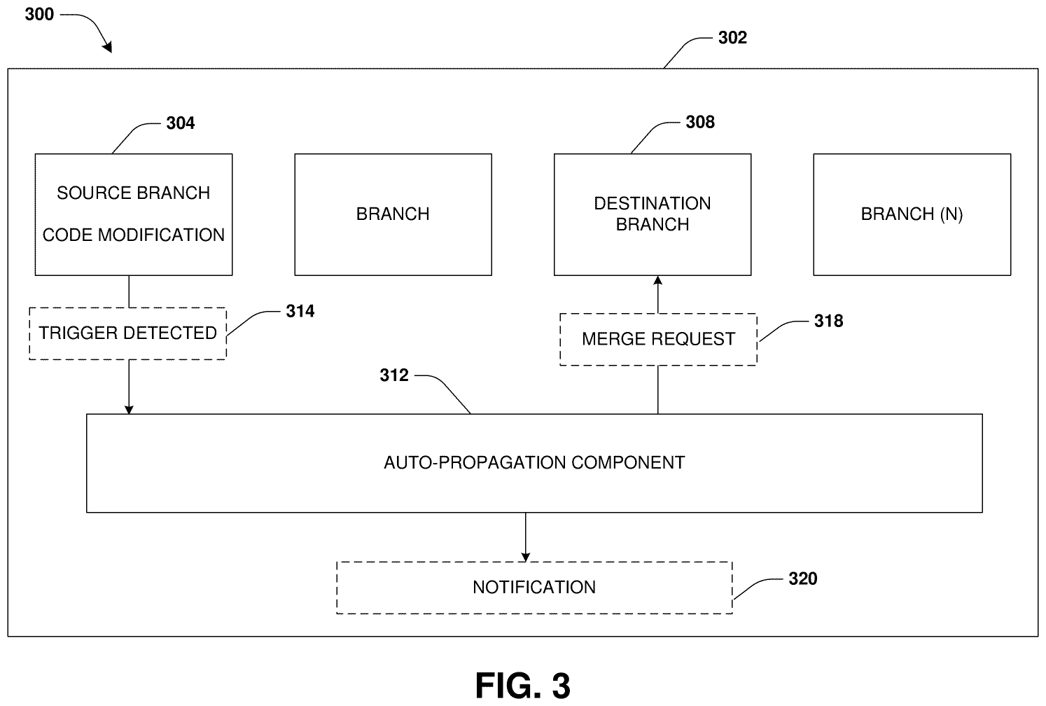

FIG. 2 is a flow chart illustrating an example method 200 for performing auto-propagation of code modifications amongst branches of a software development project 302, which is described in conjunction with system 300 of FIG. 3. An auto-propagation component 312 may be implemented as an auto-propagation add-on to a software repository hosting the software development project 302. The auto-propagation component 312 provides auto-propagation functionality not natively supported by the repository. The auto-propagation component 312 may include a script comprising auto-propagation logic (e.g., logic/code to identify code modifications, create merge requests, execute merge requests, perform conflicting resolution and troubleshooting, etc.). The auto-propagation component 312 may include a job execution machine that will execute the script as a job for tracking execution of the auto-propagation logic. The auto-propagation component 312 may include a markup language file used to define triggers (rules) that will automatically trigger the job execution machine to execute the script as the job to automatically merge code modifications from a source branch to one or more destination branches.

Triggers may be defined with various types of conditions, such as a determination that pipeline jobs have passed, a merge has been performed on a branch that is to be auto-propagated to other branches, code modifications have been submitted by a user, a certain amount of time passing since a last auto propagation, a timer expiring, an event or function of the software development platform occurring or being executed, an auto-propagation schedule indicating that auto-propagation should be triggered to propagate any code modifications, etc.

The trigger is a condition that enables the auto-propagation component 312 to identify when to initiate the processing of code auto-propagation such as the execution of the script managed by the job execution machine. In some embodiments, the condition of the trigger is used to determine whether to execute pipeline jobs or not, which relates to initiating the process of code auto-propagation.

During operation 202 of method 200, a source branch 304, of the software development project 302, is identified. The source branch 304 may be identified as having auto-propagation enabled for code modifications to the source branch 304. That is, auto-propagation may be selectively enabled for certain branches, and may be selectively disabled for other branches. During operation 204 of method 200, the software development project 302 is evaluated to identify a destination branch 308 to which the code modifications are to be propagated. In some embodiments, the auto-propagation component 312 may be configured with a rule specifying the source branch 304, the destination branch 308, and/or other destination branches to which code modifications of the source branch 304 are to be auto-propagated based upon conditions of a trigger being satisfied. In some embodiments, the source branch 304 and/or the destination branch 308 may be a release version branch, a feature branch, a master branch, a developer branch, a staging branch, or other type of branch (e.g., a branch of code for an application).

In some embodiments, the source branch 304 is a feature branch (e.g., a feature/API branch for an employee API feature of the application to obtain a name and age of an employee) and the destination branch 308 is a release version branch (e.g., a version of the application). Auto-propagation may be enabled to forward merge code modifications from the feature branch (e.g., an update to the employee API to obtain a social security number and mobile number) forward into the release version branch.

In some embodiments, the source branch 304 is a master branch (e.g., a production version of the application) and the destination branch 308 is a release version branch. Auto-propagation may be enabled to reverse merge code modifications from the master branch into the release version branch. In some embodiments, auto-propagation is executed to push code modifications made to a master branch to future release version branches corresponding to versions of the application not yet released.

During operation 206 of method 200, a trigger associated with the auto-propagation from the source branch 304 to the destination branch 308 is detected 314, such as where conditions of the trigger have been satisfied. In response to the conditions of the trigger being satisfied, the auto-propagation component 312 automatically implements auto-propagation such as where the trigger defined by the markup language is used to initiate the job execution machine to run the script as a job for auto-propagation of code modifications from the source branch 304 to the destination branch 308.

As part of implementing the auto-propagation, the auto-propagation component 312 identifies a code modification made to the source branch 304, during operation 208 of method 200. During operation 210 of method 200, the auto-propagation component 312 automatically generates and executes a merge request 318 to merge the code modification from the source branch 304 to the destination branch 308. In some embodiments, multiple merge requests are automatically generated and executed where there is a plurality of destination branches such as a first merge request for a first release version branch, a second merge request for a second release version branch, etc. In this way, a plurality of merge requests may be generated and executed in parallel on different branches within the software development project 302 (e.g., different release version branches as destination branches, different feature branches as source branches that were modified with code modifications to auto-propagate, etc.), which improves efficiency of code auto-propagation.

In some embodiments, conflict resolution may be performed during the automated execution of the merge request 318. The conflict resolution is performed in response to a determination that a code conflict exists from merging the code modification to the destination branch 308. In some embodiments, a notification 320 is generated to indicate that the code conflict exists and a result of performing the conflict resolution. In some embodiments, the notification 320 is generated based upon a notification flag being set for auto-propagation. In some embodiments, the notification 320 is generated to indicate a result of the merge request 318, such as whether the code modification was successfully merged into the destination branch 308. If execution of the merge request 318 resulting in a code issue, then the notification 320 may be populated with a link to a portion of code affected by the code issue. The notification 320 may be transmitted to a user such as a developer through email, a user interface, a slack message, etc.

In this way, auto-propagation of code modifications amongst branches is triggered to maintain code consistency across the branches of the software development project 302.

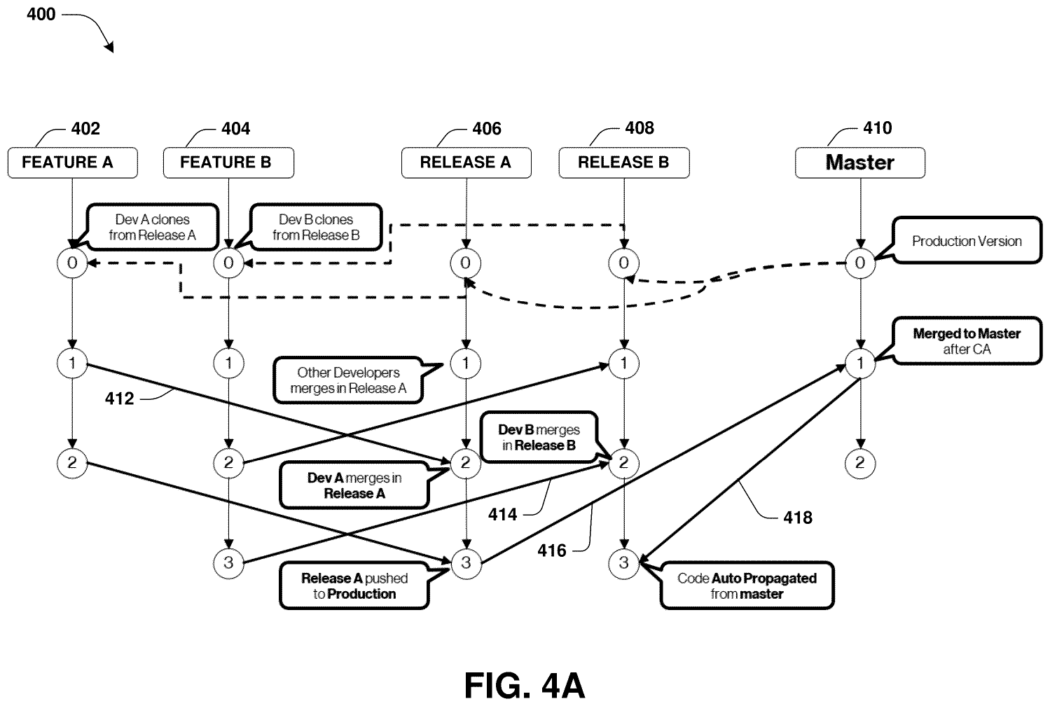

FIG. 4A is a flow chart illustrating an example method 400 for performing auto-propagation of code modifications amongst branches of a software development project. The software development project may include a feature branch (A) 402, a feature branch (B) 404, a release version branch (A) 406, a release version branch (B) 408, and a master branch 410. It may be appreciated that the software development project may include any number of branches, such as hundreds of branches where manual code merging is an onerous task that would consume a significant amount of time and manual effort that may be prone to errors. Accordingly, auto-propagation may be selectively enabled for certain branches of the software development project.

At time period 0 where there are check-in versions (0) across the branches, there may be a production version of an application represented by the master branch 410. A developer may clone code from the release version branch (A) 406 for inclusion within the feature branch (A) 402. A developer may clone code from the release version branch (B) 408 for inclusion within the feature branch (B) 404.

Over time, there may be other check-in versions such as a check-in version (1), a check-in version (2), a check-in version (3), and/or other check-in versions across the branches. Over time and across the various check-in versions, various code modifications and merges may be performed such as where a developer merges 412 code modifications into release version branch (A) 406, a developer merges 414 code modifications into release version branch (B) 408, etc. In some embodiments, the release version branch (A) 406 is pushed 416 to the master branch 410 in order to merge code modifications from the release version branch (A) 406 to the production version of the application represented by the master branch 410. This may cause condition(s) of a trigger for auto-propagation to be satisfied. Accordingly, the code modifications pushed 416 to the master branch 410 are auto-propagated 418 (reverse merged) from the master branch 410 (source branch) to the release version branch (B) 408 (destination branch) based upon the trigger occurring. In this way, the code modifications are synchronized amongst the master branch 410, the release version branch (A) 406, and the release version branch (B) 408.

FIG. 4B is a flow chart illustrating an example method 450 for performing auto-propagation of code modifications amongst branches of a software development project. The software development project may include the feature branch (A) 402, the feature branch (B) 404, the release version branch (A) 406, the release version branch (B) 408, and the master branch 410.

At time period 0 where there are check-in versions (0) across the branches, there may be a production version of an application represented by the master branch 410. Over time, there may be other check-in versions such as a check-in version (1), a check-in version (2), a check-in version (3), and/or other check-in versions across the branches. A developer may clone code from the master branch 410 for inclusion within the feature (A) branch 402. A developer may clone code from the release version branch (A) 406 for inclusion within the feature branch (B) 404. A developer may clone code from the release version branch (A) 406 for inclusion within the release version branch (B) 408.

In some embodiments, a trigger may be detected where conditions of the trigger have been satisfied. The trigger may specify the feature branch (B) 404 is a source branch and that release version branch (A) 406 and release version branch (B) 408 are destination branches. Accordingly, code modifications of feature branch (B) 404 are auto-propagated 456 (forward merged) to the release version branch (A) 406 and are auto-propagated 458 (forward merged) to the release version branch (B) 408. After the auto-propagations, the release version branch (A) 406 may be pushed 460 to the master branch 410. The release version branch (B) 408 may be subsequently pushed 462 to the master branch 410. The release version branches that are pushed to the master branch 410 include the code modifications that were auto-propagated from the feature branch (B) 404 to the release version branches, such that the master branch 410 will include such code modifications.

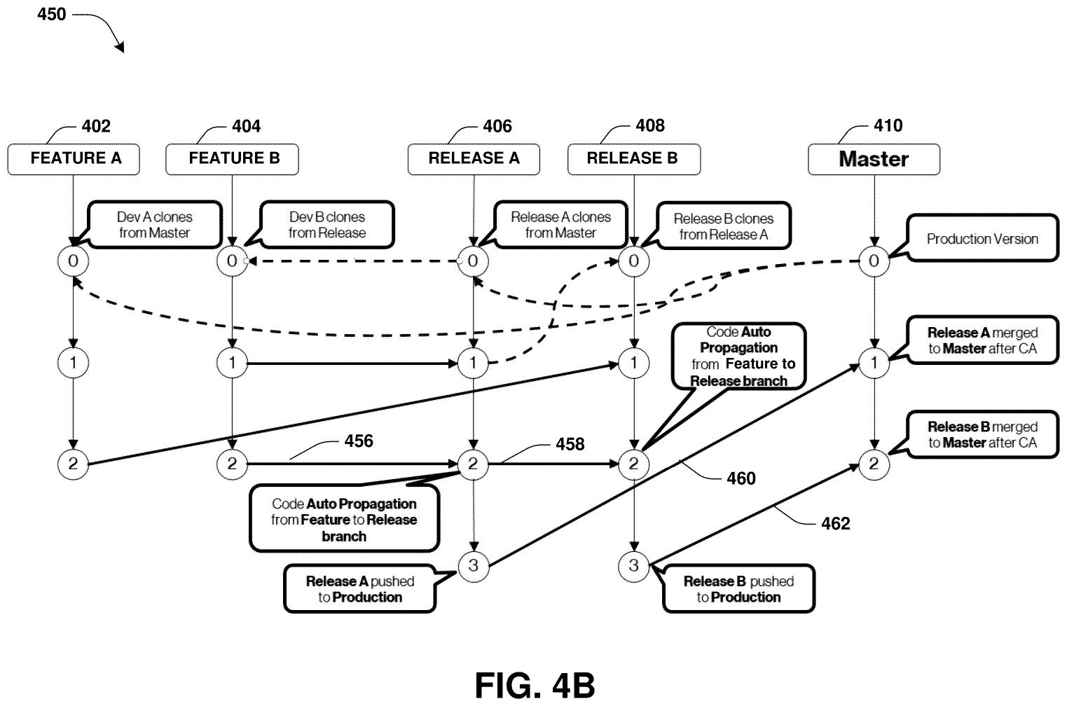

FIG. 5 illustrates an example of a system 500 for providing a notification 506 regarding the auto-propagation of code modifications amongst branches of a software development project. The auto-propagation component 502 provides the ability to define features flags 504 that can be enabled or disabled. A feature flag has an identifier, an enable status, and a notification rule. A notification rule may specify that auto-propagation is to be enabled for a certain source branch and one or more destination branches. A notification rule may specify that an email is to be sent if a code conflict/issue is identified. A notification rule may specify that a notification such as a slack notification is to be sent if a code conflict/issue is identified. A notification rule may specify that an email is to be sent when a merge request is created and/or executed through auto-propagation. A notification rule may specify that a slack notification to be sent when a merge request is created and/or executed through auto-propagation. In this way, various notifications/emails may be generated and sent by the auto-propagation component 502.

According to some embodiments, a method is provided. The method includes identifying a source branch, of a software development project, for which auto-propagation is enabled for code modifications to the source branch; evaluating the software development project to identify a destination branch to which the code modifications are to be propagated; and in response to identifying a trigger associated with the auto-propagation for the source branch: identifying a code modification made to the source branch; automatically generating a merge request to merge the code modification from the source branch to the destination branch; and executing the merge request to merge the code modification from the source branch to the destination branch.

According to some embodiments, the source branch is a feature branch and the destination branch is a release version branch, and wherein the auto-propagation is implemented as a forward merge to merge the code modification from the feature branch forward into the release version branch.

According to some embodiments, the source branch is a master branch and the destination branch is a release version branch, and wherein the auto-propagation is implemented as a reverse merge to merge the code modification from the master branch into the release version branch.

According to some embodiments, the source branch or the destination branch comprises at least one of a release version branch, a feature branch, a master branch, a developer branch, or a staging branch.

According to some embodiments, the method includes in response to a notification flag being set for the auto-propagation, generating and transmitting a notification to a developer regarding an outcome of executing the merge request.

According to some embodiments, the method includes in response to determining that the outcome indicates that a code issue occurred from executing the merge request, generation the notification to link to a portion of code affected by the code issue.

According to some embodiments, the method includes defining the trigger as a determination as to whether a pipeline job is to be executed.

According to some embodiments, the method includes during automated execution of the merge request, performing conflict resolution based upon a determination that a code conflict exists from merging the code modification into the destination branch.

According to some embodiments, the method includes triggering auto-propagation for the code modifications to maintain code consistency across branches of the software development project.

According to some embodiments, a system comprising one or more processors configured for executing the instructions to perform operations, is provided. The operations include identifying a source branch, of a software development project, for which auto-propagation is enabled for code modifications to the source branch; evaluating the software development project to identify a destination branch to which the code modifications are to be propagated; and in response to identifying a trigger associated with the auto-propagation for the source branch: identifying a code modification made to the source branch; automatically generating a merge request to merge the code modification from the source branch to the destination branch; and executing the merge request to merge the code modification from the source branch to the destination branch.

According to some embodiments, the destination branch is a first release version branch, and the operations include auto-propagating the code modification to a plurality of destination branches that include the first release version branch and a second release version branch.

According to some embodiments, the operations include generating and executing a plurality of merge requests in parallel on different branches within the software development project.

According to some embodiments, the operations include generating and executing a plurality of merge requests in parallel on different branches within the software development project, wherein the different branches corresponds to different feature branches being modified.

According to some embodiments, the operations include integrating an auto-propagation add-on into a software development platform to provide auto-propagation functionality not natively supported by the software development platform, wherein the auto-propagation add-on includes a script comprising auto-propagation logic, a job execution machine that will execute the script as a job, and a markup language file used to define the trigger.

According to some embodiments, a non-transitory computer-readable medium storing instructions that when executed facilitate performance of operations, is provided. The operations include identifying a source branch, of a software development project, for which auto-propagation is enabled for code modifications to the source branch; evaluating the software development project to identify a destination branch to which the code modifications are to be propagated; and in response to identifying a trigger associated with the auto-propagation for the source branch: identifying a code modification made to the source branch; automatically generating a merge request to merge the code modification from the source branch to the destination branch; and executing the merge request to merge the code modification from the source branch to the destination branch.

According to some embodiments, the operations include executing the auto-propagation to push code modifications made to a master branch to future release version branches.

According to some embodiments, the operations include defining a new trigger as a merge being performed on a first branch that is to be auto-propagated to a second branch.

According to some embodiments, the operations include in response to a notification flag being set for the auto-propagation, generating and transmitting a notification to a developer regarding an outcome of executing the merge request.

According to some embodiments, the source branch is a feature branch and the destination branch is a release version branch, and wherein the auto-propagation is implemented as a forward merge to merge the code modification from the feature branch forward into the release version branch.

According to some embodiments, the source branch is a master branch and the destination branch is a release version branch, and wherein the auto-propagation is implemented as a reverse merge to merge the code modification from the master branch into the release version branch.

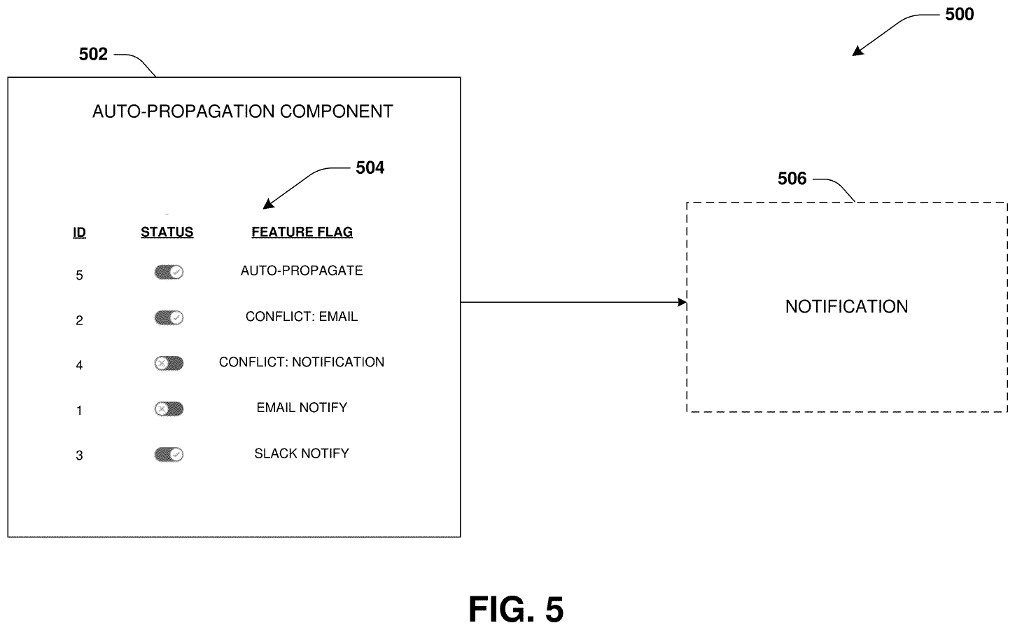

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, for example. In some embodiments, the processor-executable instructions 612 are configured to cause implementation of a system, such as at least some of the example system 100 of FIG. 1, at least some of example system 300 of FIG. 3.

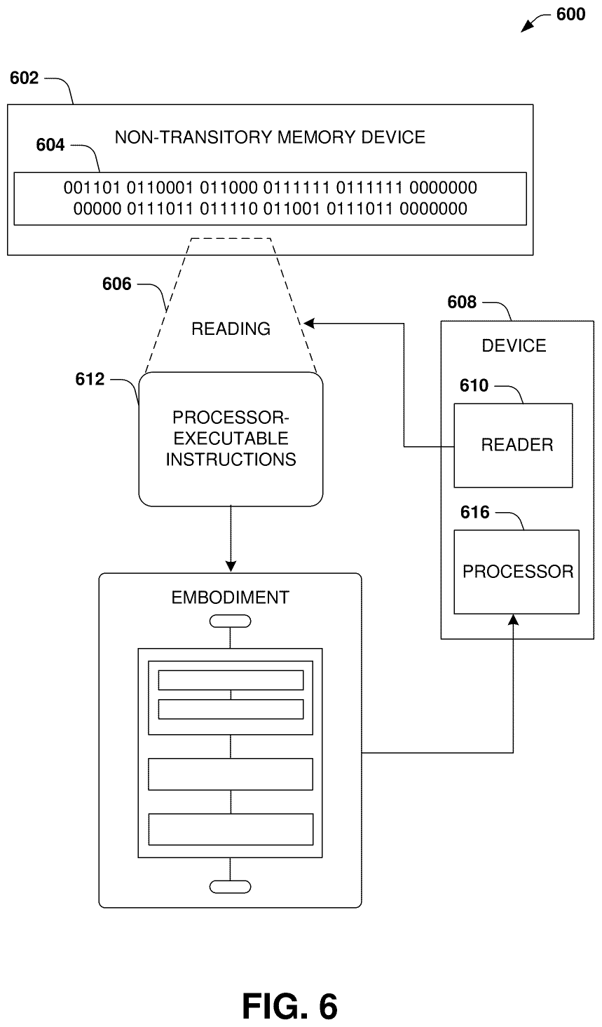

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

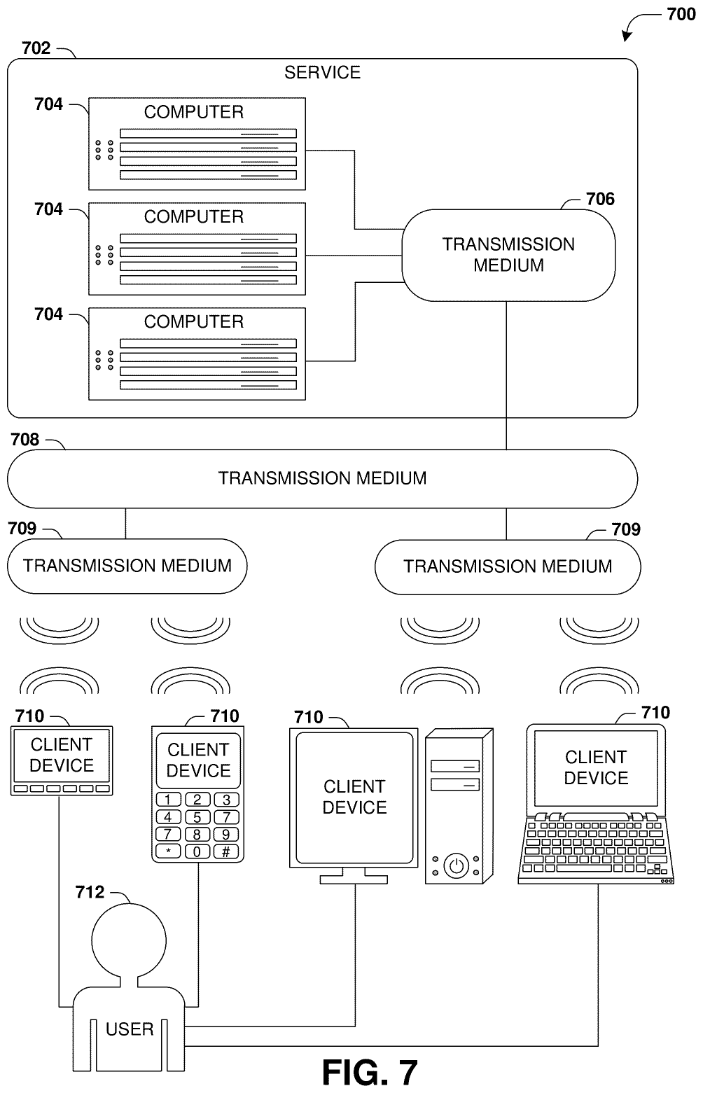

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

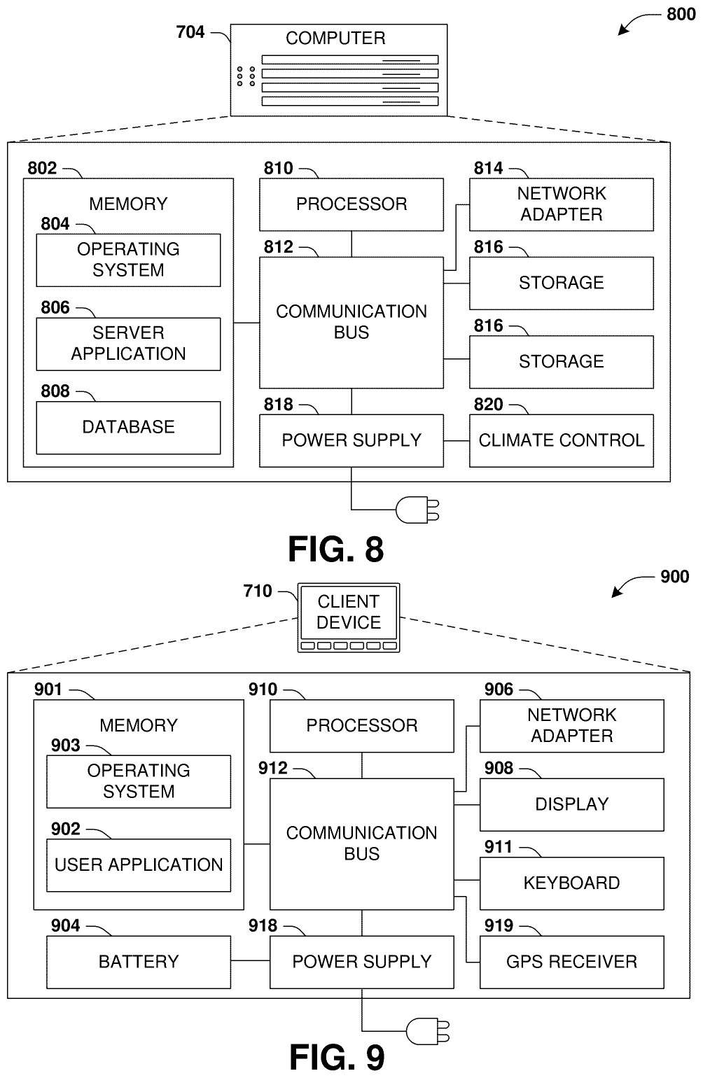

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
identifying a source branch, of source code for a software development project, for which auto-propagation is enabled for code modifications to the source branch;
evaluating the software development project to identify a destination branch to which the code modifications are to be propagated; and
in response to identifying a trigger associated with the auto-propagation for the source branch:
identifying a code modification made to the source branch;
automatically generating a merge request to merge the code modification from the source branch to the destination branch; and
executing the merge request to merge the code modification from the source branch to the destination branch.

2. The method of claim 1, wherein the source branch is a feature branch and the destination branch is a release version branch, and wherein the auto-propagation is implemented as a forward merge to merge the code modification from the feature branch forward into the release version branch.

3. The method of claim 1, wherein the source branch is a master branch and the destination branch is a release version branch, and wherein the auto-propagation is implemented as a reverse merge to merge the code modification from the master branch into the release version branch.

4. The method of claim 1, wherein the source branch or the destination branch comprises at least one of a release version branch, a feature branch, a master branch, a developer branch, or a staging branch.

5. The method of claim 1, comprising:
in response to a notification flag being set for the auto-propagation, generating and transmitting a notification to a developer regarding an outcome of executing the merge request.

6. The method of claim 5, comprising:
in response to determining that the outcome indicates that a code issue occurred from executing the merge request, generation the notification to link to a portion of code affected by the code issue.

7. The method of claim 1, comprising:
defining the trigger as a determination as to whether a pipeline job is to be executed.

8. The method of claim 1, comprising:
during automated execution of the merge request, performing conflict resolution based upon a determination that a code conflict exists from merging the code modification into the destination branch.

9. The method of claim 1, comprising:
triggering auto-propagation for the code modifications to maintain code consistency across branches of the software development project.

10. A system, comprising:
one or more processors configured for executing instructions to perform operations comprising:
identifying a source branch, of a software development project, for which auto-propagation is enabled for code modifications to the source branch;
evaluating the software development project to identify a destination branch to which the code modifications are to be propagated; and
in response to identifying a trigger associated with the auto-propagation for the source branch:
identifying a code modification made to the source branch;
automatically generating a merge request to merge the code modification from the source branch to the destination branch; and
executing the merge request to merge the code modification from the source branch to the destination branch.

11. The system of claim 10, wherein the destination branch is a first release version branch, and wherein the operations further comprise:
auto-propagating the code modification to a plurality of destination branches that include the first release version branch and a second release version branch.

12. The system of claim 10, wherein the operations further comprise:
generating and executing a plurality of merge requests in parallel on different branches within the software development project.

13. The system of claim 10, wherein the operations further comprise:
generating and executing a plurality of merge requests in parallel on different branches within the software development project, wherein the different branches corresponds to different feature branches being modified.

14. The system of claim 10, wherein the operations further comprise:
integrating an auto-propagation add-on into a software development platform to provide auto-propagation functionality not natively supported by the software development platform, wherein the auto-propagation add-on includes a script comprising auto-propagation logic, a job execution machine that will execute the script as a job, and a markup language file used to define the trigger.

15. A non-transitory computer-readable medium storing instructions that when executed facilitate performance of operations comprising:
identifying a source branch, of a software development project, for which auto-propagation is enabled for code modifications to the source branch;
evaluating the software development project to identify a destination branch to which the code modifications are to be propagated; and
in response to identifying a trigger associated with the auto-propagation for the source branch:
identifying a code modification made to the source branch;
automatically generating a merge request to merge the code modification from the source branch to the destination branch; and
executing the merge request to merge the code modification from the source branch to the destination branch.

16. The non-transitory computer-readable medium of claim 15, wherein the operations further comprise:
executing the auto-propagation to push code modifications made to a master branch to future release version branches.

17. The non-transitory computer-readable medium of claim 15, wherein the operations further comprise:
defining a new trigger as a merge being performed on a first branch that is to be auto-propagated to a second branch.

18. The non-transitory computer-readable medium of claim 15, wherein the operations further comprise:
in response to a notification flag being set for the auto-propagation, generating and transmitting a notification to a developer regarding an outcome of executing the merge request.

19. The non-transitory computer-readable medium of claim 15, wherein the source branch is a feature branch and the destination branch is a release version branch, and wherein the auto-propagation is implemented as a forward merge to merge the code modification from the feature branch forward into the release version branch.

20. The non-transitory computer-readable medium of claim 15, wherein the source branch is a master branch and the destination branch is a release version branch, and wherein the auto-propagation is implemented as a reverse merge to merge the code modification from the master branch into the release version branch.
